(19) United States
(12) Patent Application Publication
(10) Pub. No.: US 2017/0177927 A1
(43) Pub. Date: Jun. 22, 2017

(54) IMPRESSION ANALYSIS DEVICE, GAME DEVICE, HEALTH MANAGEMENT DEVICE, ADVERTISING SUPPORT DEVICE, IMPRESSION ANALYSIS SYSTEM, IMPRESSION ANALYSIS METHOD, AND PROGRAM RECORDING MEDIUM

(71) Applicant: NEC Solution Innovators, Ltd., Koto-ku, Tokyo (JP)

(72) Inventors: Mitsuhiro Fujita, Tokyo (JP); Yasuyuki Ihara, Tokyo (JP); Tomomi Kinoshita, Tokyo (JP)

(73) Assignee: NEC Solution Innovators, Ltd., Koto-ku, Tokyo (JP)

(21) Appl. No.: 15/115,738

(22) PCT Filed: Feb. 13, 2015
(86) PCT No.: PCT/JP2015/000671

§ 371 Date: Aug. 1, 2016

(30) Foreign Application Priority Data
Feb. 17, 2014 (JP) 2014-027981

(51) Int. Cl. G06K 9/00; G06Q 30/02; G06K 9/62

(52) U.S. Cl. CPC G06K 9/00308; G06K 9/00281; G06K 9/00288; G06K 9/6255; G06Q 30/0269

(57) ABSTRACT

Provided are: an impression analysis device with which it is possible to easily obtain a facial image evaluation of a person being evaluated; a game device; a health management device; an impression analysis system; an impression analysis method; a program; and a program recording medium. This impression analysis device (2) is characterized by comprising: a storage unit (11) which associates the pre-acquired facial image with the impression evaluation of the impression evaluator with respect to the facial image, and stores these pairs as impression information; a learning unit (12) which extracts characteristic parts from the facial images, and refers to the impression information to generate evaluation criteria; and an impression analysis result generating unit (13) that prepares, using the evaluation criteria generated by the learning unit (12), an impression evaluation from the facial image of a person being evaluated.

This application is a National Stage Entry of PCT/JP2015/000671 filed on Feb. 13, 2015, which is based on and claims the benefit of Japanese Patent Application No. 2014-027981 filed on Feb. 17, 2014, and the entire disclosures of the above application are incorporated herein by reference.

### TECHNICAL FIELD

The present invention relates to an impression analysis device, a game device, a health management device, an advertising support device, an impression analysis system, an impression analysis method, a program, and a program recording medium.

### BACKGROUND ART

Recently, with a rapid improvement of facial image recognition technique, a technique for estimating attribute information such as age, gender and the like, is utilized in vending machines and digital signages (Patent Literature 1, for example). The facial image recognition technique is widely applicable for marketing, security and the like, and becoming an important technique to deploy services adjusted for individuals.

### CITATION LIST

### Patent Literature

[PTL 1] JP 2011-18125 A

### SUMMARY OF INVENTION

### Technical Problem

However, an example utilizing the facial image recognition technique for a face impression analysis has not existed before. On the other hand, an impression evaluation of a face of a person to be evaluated by other people is a matter of interest. However, the problems are, it is not easy to ask other people about the impression evaluation of the face of the person to be evaluated, and an objective evaluation cannot be acquired easily.

Accordingly, an exemplary object of the present invention is to provide an impression analysis device, a game device, a health management device, an advertising support device, an impression analysis system, an impression analysis method, a program, and a program recording medium, that can easily acquire an impression evaluation about the face of a person to be evaluated.

### Solution to Problem

To achieve the exemplary object, an impression analysis device according to the present invention includes: a storage unit that stores, as impression information, a preliminarily acquired facial image and an impression evaluation with respect to the facial image by an impression evaluator, to be stored in such a manner that the facial image is associated with the impression evaluation; a learning unit that extracts a feature point from the facial image and generates an evaluation criterion by referring to the impression information; and an impression analysis result generation unit that generates an impression evaluation result from a facial image of a person to be evaluated, based on the evaluation criterion generated by the learning unit.

To achieve the exemplary object, a game device according to the present invention includes the impression analysis device of the present invention.

To achieve the exemplary object, a health management device according to the present invention includes the impression analysis device of the present invention.

To achieve the exemplary object, an advertising support device according to the present invention includes the impression analysis device of the present invention.

To achieve the exemplary object, an impression analysis system according to the present invention includes: a server including the impression analysis device according to the present invention; an input terminal; and an output terminal. The input terminal and the output terminal are connected to the server via a communication line network; the input terminal includes at least one of a unit that inputs the specific impression evaluation and a unit that captures a facial image of the person to be evaluated; and the output terminal includes at least one of a unit that displays the detected impression evaluation and a means that displays at least one from the group consisting of the impression analysis result generated by the impression analysis result generation unit, the impression analysis result image, the advertisement information, and the impression comparison result.

To achieve the exemplary object, an impression analysis method according to the present invention includes: storing, as impression information, a preliminarily acquired facial image and an impression evaluation with respect to the facial image by an impression evaluator, to be stored in such a manner that the facial image is associated with the impression evaluation; extracting a feature point from the facial image and generating an evaluation criterion by referring to the impression information; and generating an impression analysis result based on a facial image of a person to be evaluated, using the evaluation criterion.

To achieve the exemplary object, a program according to the present invention is for causing a computer to perform the above impression analysis method of the present invention.

To achieve the exemplary object, a program recording medium according to the present invention is a computer-readable recording medium that records the above program.

### Advantageous Effects of Invention

The present invention can provide an impression analysis device, a game device, a health management device, an advertising support device, impression analysis system, an impression analysis method, a program, and a program recording medium, that can easily acquire an impression evaluation about the face of a person to be evaluated.

### BRIEF DESCRIPTION OF DRAWINGS

FIG. 1 is a block diagram showing one exemplary configuration of an impression analysis system of a first exemplary embodiment of the present invention.

FIG. 2 shows a block diagram of one example of the impression analysis device according to the first exemplary embodiment of the present invention.

FIG. 3 is a flowchart showing one example of an impression analysis method according to the first exemplary embodiment of the present invention.

FIG. 4 is a diagram showing one example of the use of the impression analysis system according to the first exemplary embodiment of the present invention.

FIG. 5 is a block diagram showing one example of an impression analysis device according to a second exemplary embodiment of the present invention.

FIG. 6 is a flowchart showing one example of the impression analysis method according to the second exemplary embodiment of the present invention.

FIG. 7 is a flowchart showing one example of an impression analysis method according to the second exemplary embodiment of the present invention.

FIG. 8 is a diagram showing one example of the use of the impression analysis system according to the second exemplary embodiment of the present invention.

FIG. 9 is a diagram showing one example of the use of a game device according to a third exemplary embodiment of the present invention.

FIG. 10 is a diagram showing one example of the use of a health management device according to a fourth exemplary embodiment of the present invention.

FIG. 11 is a diagram showing one example of a hardware configuration of the impression analysis device according to the first exemplary embodiment of the present invention.

### DESCRIPTION OF EMBODIMENTS

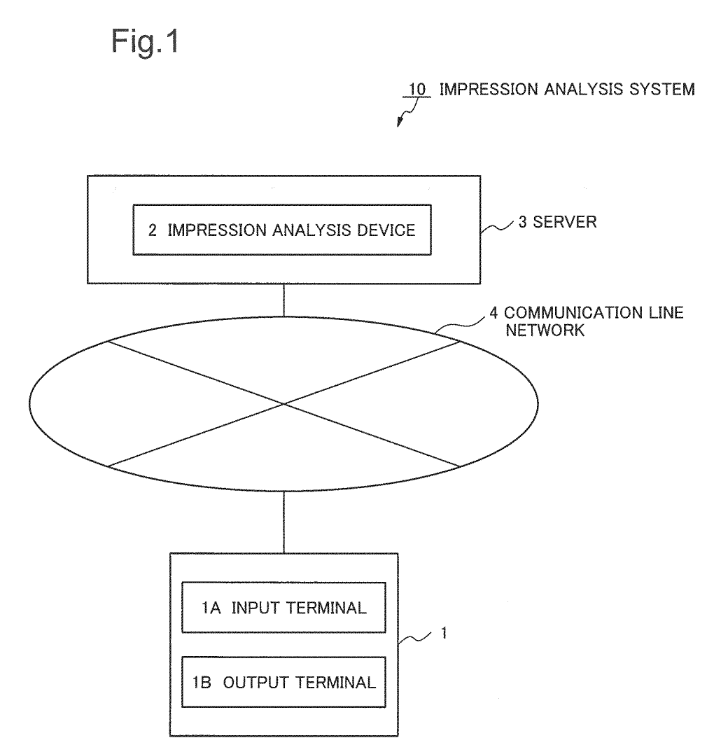

The present invention is described by way of example. However, the scope of the present invention is not limited by the following description. From FIG. 1 to FIG. 10, there is a case that the same symbol is given to the same unit, and the explanation is omitted.

### The First Exemplary Embodiment

### (Impression Analysis System)

FIG. 1 is a block diagram showing a configuration of one example of an impression analysis system 10 of the present exemplary embodiment. As shown in the diagram, the impression analysis system 10 includes a server 3 including an impression analysis device 2, an input terminal 1A and an output terminal 1B as major components. As shown in FIG. 1, the input terminal and the output terminal 1 are connected to the server 3 via a communication line network 4. The communication line network 4 is not limited. Public communication line networks can be used as the communication line network 4. Specifically, the communication line network 4 may include the internet line, telephone line, LAN (Local Area Network) and the like. The communication line network 4 may be wireless, wired, or a communication line of the combination of these.

### (Input Terminal and Output Terminal)

The input terminal and the output terminal 1 may be a same terminal, or individual terminals.

The input terminal 1A includes at least one of a unit that inputs a specific impression evaluation and a unit that captures a facial image of a person to be evaluated. The output terminal 1B includes at least one of a unit that displays impression information detected by an impression information detection unit, and a unit that displays at least one from the group consisting of an impression analysis result generated by an impression analysis result generation unit 13, an impression analysis result image, advertising information, and an impression comparison result. The examples of the unit that inputs a specific impression evaluation include a general text input unit or a speech input unit and the like. An image capturing unit includes a CCD (Charge Coupled Device) camera, a CMOS (Complementary Metal Oxide Semiconductor) camera, or a scanner and the like. The input terminal and the output terminal 1 is not particularly limited. For example, The input terminal and the output terminal 1 includes a mobile phone, a smartphone, a personal computer (PC), a tablet terminal and the like, preferably a mobile phone, a smartphone or a tablet terminal. The output terminal 1B may further include a unit that displays the facial image to be evaluated when inputting the impression evaluation.

As described below, the impression analysis device 2 of the present exemplary embodiment may include the input terminal 1A and the output terminal 1B as an input unit and an output unit respectively. In this case, the impression analysis device 2 is connected directly to the server 3 as the input unit and output unit, without connected to the communication line network 4.

### (Impression Analysis Device)

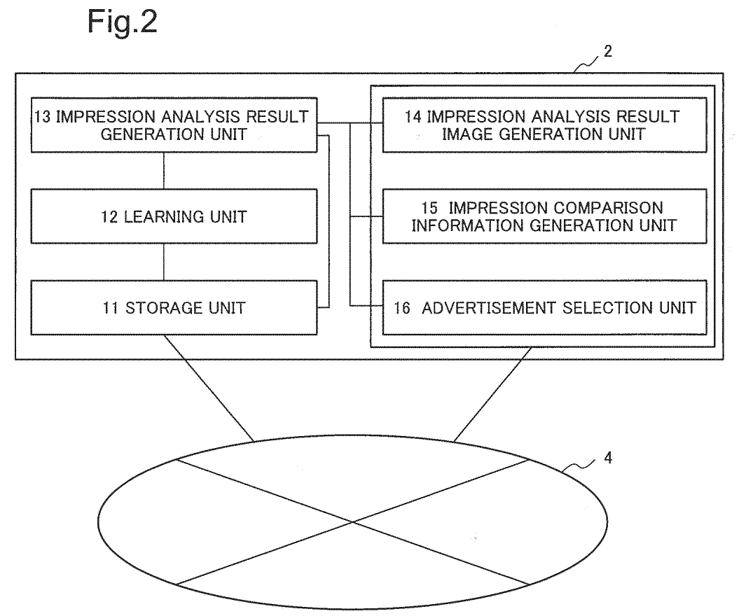

FIG. 2 is a block diagram showing a configuration of one example of the impression analysis device 2 of the present exemplary embodiment. The device 2 of the present exemplary embodiment shown in FIG. 2 includes a storage unit 11, a learning unit 12, an impression analysis result generation unit 13, an impression analysis result image generation unit 14, an impression comparison information generation unit 15 and an advertisement selection unit 16. As shown in FIG. 2, the storage unit 11, impression analysis result image generation unit 14, impression comparison information generation unit 15 and the advertisement selection unit 16 are connectable to the communication line network 4.

The storage unit 11 stores, as impression information, a preliminarily acquired facial image and an impression evaluation with respect to the facial image by an impression evaluator, to be stored in such a manner that the facial image is associated with the impression evaluation. The storage unit 11, for example, may store a facial image of the person to be evaluated. The learning unit 12 generates an evaluation criterion by extracting a feature point from the stored facial image and referring to the impression information. The impression analysis result generation unit 13 generates an impression analysis result from the facial image of the person to be evaluated, based on the evaluation criterion generated by the learning unit 12. For example, in the case that the facial image of the person to be evaluated is stored in the storage unit 11, the impression analysis result generation unit 13 generates the impression analysis result from the facial image of the person to be evaluated stored in the storage device 11.

The impression analysis result image generation unit 14 generates an impression analysis result image based on the impression analysis result generated by the impression analysis result generation unit. The impression comparison information generation unit 15 generates an impression comparison result by comparing the impression analysis results of each of the facial images generated by the impression analysis result generation unit 13. The advertisement selection unit 16 selects an advertisement according to the impression analysis result of the person to be evaluated. The impression analysis result image generation unit 14, impression comparison information generation unit 15 and the advertisement selection unit 16 are arbitrary components. The impression analysis device 2 may include at least one of these.

The storage unit 11 is not limited. The storage unit 11 includes, for example, a database or a server, a random access memory (RAM), a read-only memory (ROM), a hard disk (HD), an optical disk, a floppy (trademark) disk (FD) and the like. The storage unit 11 may be, for example, a built-in type or an external type such as external storage device.

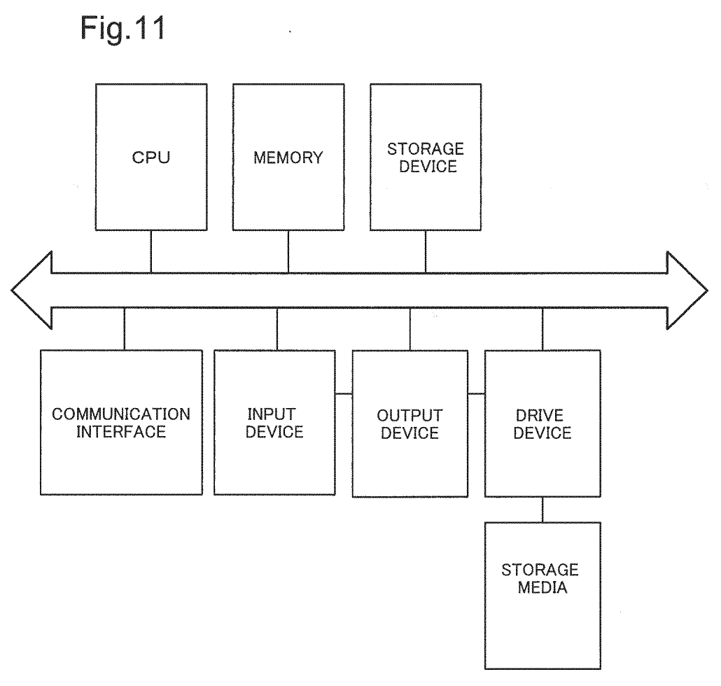

FIG. 11 is an explanatory diagram of one example of a hardware configuration that is capable of realizing the impression analysis device 2 according to the first exemplary embodiment. The hardware configuring the impression analysis device 2 (computer) includes a CPU (Central Processing Unit), a memory, a storage device, and a communication interface (I/F). The impression analysis device 2 may include an input device or an output device. The function of the impression analysis device 2 is realized by the CPU executing a computer program (software program, hereinafter referred to as program) read out onto the memory. When executing, the CPU appropriately controls the communication interface, input device and the output device.

Also, each component of the first exemplary embodiment may include, for each component respectively, hardware configuration shown in FIG. 11.

The present exemplary embodiment and the present invention explained with each exemplary embodiment described below as an example may be configured by a non-volatile storage medium such as compact disc and the like that stores the program therein. The program stored in the storage medium may be, for example, read out by a drive device.

A communication executed by the impression analysis device 2 is realized by, for example, an application program controlling the communication interface utilizing a function provided by an OS (Operating System).

The impression analysis device 2 may be configured by two or more physically separate devices connected with or without wires.

The example of the hardware configuration shown in FIG. 11 is applicable for each exemplary embodiment described below and each specific example. The impression analysis device 2 may be a dedicated device. The hardware configuration of the impression analysis device 2 and each function block thereof are not limited to the above-described configuration.

In the present exemplary embodiment, the facial image is not limited and, for example, may be an image from front, side, oblique above or from below. Also, the facial image may include hair or accessories such as pierced earrings or earrings.

In the present exemplary embodiment, the impression evaluators are not limited, and may be an unspecified number of persons, a specified number of persons, or only the users themselves. Also, the impression evaluators may be fixed, or may be changed from time to time. In the case that the impression evaluators are composed of an unspecified number of people, the impression analysis result of the face of the user by the general public can be known. Hence, for example, the knowledge of how to enhance the charming feature of the users can be acquired.

In the case that the impression evaluators are composed only of the users themselves, the preliminarily acquired facial images can be sorted and selected according to the viewpoint of the person to be evaluated. The group of a specified number of persons is, without limitation, a group of people composed of persons belonging to at least one of the group consisting of a specific business type, job type, and attribute, for example. The specific business types include, for example, the service industry, banking industry, health industry, beauty salon business and the like. The examples of the job types include sales position, a human resources division of a company that conducts interviews and the like. Job types include, preferably, professionals such as doctors and the like, or well-known specialist of beauty or health and the like. Examples of attributes include gender, age, a target demographic of a specific product and the like, and may be a combination of these. Examples of the combined attribute include, specifically, a demographic of elderly males, male company employees in the forties and the like.

By limiting the impression evaluators to a specified number of persons, the person to be evaluated can acquire an objective and accurate evaluation of his impression. Specifically, for example, in the case that the impression evaluators are composed of interviewers belonging to a human resource division, the user of the impression analysis system can learn the good impression for the interviewers. Further, for example, in the case the impression evaluators are composed of beauty specialists, the person to be evaluated in the impression analysis system can acquire a more objective and accurate impression analysis result about the facial image of the person to be evaluated himself.

Moreover, for example, when the impression evaluators are composed of an elderly demographic, the impression analysis system user can learn the appropriate impression at Buddhist memorial services and the like. Moreover, for example, a case is considered in which the impression analysis system user is a dealer of a specific product, and the impression evaluators are composed of the target demographic of the specific product. In this case, the user can learn the point of view by the target demographic about the employees (target persons to be evaluated), so the user can improve their services for customers.

In the present exemplary embodiment, impression elements in the impression evaluation is not limited, and may be fixed or may be changed appropriately by addition, deletion and the like. The impression elements include, specifically, cheerfulness, freshness, cuteness, goodness of the look as a businessman, tenderness, healthiness, coquettishness, chicness, elegance, dandiness, wildness and the like. Examples of impression elements also include the impression of the facial expression at the time of such as a bad mood, anger, irritation, fatigue, and the like.

The impression evaluation may be, without limitation, any evaluation of the impression elements; however, an impression evaluation according to a specific situation is preferable. Examples of impression evaluations according to a specific situation include whether the impression elements are appropriate or inappropriate in ceremonial occasions such as a wedding ceremony or a Buddhist memorial ceremony, a meeting of PTA (Parent-Teacher Association) or a party, whether the makeup is matched or not matched, whether the impression elements meet the standard of a specific company or not, and the like. Hence, the person to be evaluated can learn, in a specific situation, if his appearance is appropriate or not for the scene, and can handle the situation properly. Also, an impression evaluation according to a specific situation may be an impression evaluation of an appearance of a stranger who is affected by a specific product or a service. Specific examples thereof include whether a person is satisfied or feels bored in a situation that he is watching a specific movie at a theater, whether a person is interested or bored at a business negotiation, and the like. Thus, the user of the impression analysis system can acquire the information about whether the person to be evaluated is interested or not and the like, and the user of the impression analysis system can change the response accordingly. Specifically, in a specified situation of a business negotiation, with the impression evaluation against the facial image of the person to be evaluated, it will become easier to make a projection if he will close the deal or not. Also, an impression evaluation according to a specific situation may be an impression evaluation of an appearance of a stranger whose body and mental conditions are reflected. Specifically, the examples include a person who is likely to suicide himself at a railway platform, a suspicious individual or a shoplifter at a convenience store, or a drunk person at a sobriety checkpoint and the like. Thus, for example, the evaluation helps preliminarily detecting the behavior of the person to be evaluated, and is useful for preventing crimes, accidents and the like.

The impression analysis result may be quantified as follows: for example, the degree of beauty is 70 points, makeup trend is 91 points, the degree of brightness and freshness is 85 points, cuteness is 72 points, and so on. Also, impression analysis result may include an acceptance criterion, and acceptance judgements include an acceptance judgment of a smile face and the like. Thus, for example, since a customer-facing employee can check his own smile every day, the impression analysis device can be utilized as a service training tool. In addition, for example, the impression analysis device can be installed at a career center of a collage or a public employment security office (for example, “Hello Work” in Japan) and is able to be utilized as a training support device of a job interview. Also, it can be utilized as a training support device for people who appear in the public, for example, at a lecture meeting or teachers.

An impression analysis result is, for example, an estimation result of an impression evaluation given by an impression evaluator. Moreover, in addition to the estimation result, the impression analysis result includes at least one of an advice based on the purpose of use and a recommendation, preferably. The advice may be, without limitation, for example, a recommendation of makeup, glasses or hairstyle that matches the facial features of the facial image, an improvement of the makeup or the facial expression such as a smile of the facial image and the like. The recommendation may be products such as a suitable makeup product, glasses, a wig and the like for improving the impression of the facial expression, or a shop selling such products. Also, the recommendation may be, for example, an advertisement of a service and the like that instructs a makeup and the like suitable for a specific occasion such as ceremonial occasion and the like.

In the present exemplary embodiment, examples of feature points include, without limitation, a part of the face, a hairstyle, an accessory such as an earring or a pierced earing, glasses, a makeup product and the like. Examples of the parts of the face include an outer corner of an eyebrow, an inner corner of an eyebrow, an outer corner of an eye, an inner corner of an eye, corners of a mouth, an upper lip, a chin, a pupil of an eye and the like. The makeup products include a colored contact lens, a fake eyelash, a lipstick, a blusher, an eyeshadow and the like.

In the present exemplary embodiment, examples of the impression analysis result images include, without limitation, a graph such as a radar chart quantifying a plurality of impression analysis results per each impression element and the like. The impression analysis result image further includes, preferably, a processed facial image of the person to be evaluated, based on the impression analysis result. Examples of the processed facial images include, without limitation, a face with an improved makeup based on the advice, a face after a plastic surgery and the like.

In the present exemplary embodiment, examples of the impression comparison results include, without limitation, specifically, an impression comparison result between before and after applying a makeup, before and after wearing glasses, or before and after changing a hairstyle, an impression comparison result between before and after applying a plastic surgery or an aesthetic treatment, an impression comparison result between before and after training at a gym, and the like. Moreover, the impression comparison result can be displayed in the form of a graph such as a radar chart quantifying the impression analysis result of each impression element.

In the present exemplary embodiment, the advertisements include, without limitation, a general product or a service, a shop and the like. An advertisement can be, specifically, for example, according to an impression of a facial image, or a desired impression specified by a person to be evaluated, a suitable product such as a makeup product, glasses, wig and the like or a shop selling such products. Also, advertisements include, specifically, a service and the like that provides advice for a suitable makeup and the like for a specific occasion such as a ceremonial occasion and the like.

The impression analysis device 2 may further include an input unit and an output unit. In this case, the input unit includes at least one of a unit for inputting a specific impression evaluation, and a unit for capturing a facial image of a person to be evaluated. Moreover, the output unit includes at least one of a unit for displaying a detected impression information and a unit for displaying at least one from the group consisting of an impression analysis result generated by the impression analysis result generation unit, an impression analysis result image, advertisement information, and an impression comparison result. The output unit may include a unit for displaying a facial image for evaluation when an impression evaluation is inputted.

The impression analysis device 2 can be suitably used for a wide range of fields and industries. Specifically, the examples include, cosmetics (field) industry, wedding or job placement industry, gaming field (industry), health field (industry), advertising field (industry) and the like.

The impression analysis system 10 may be utilized in the form of cloud computing. Hence a system adjusted for timely trend can be supplied. Specifically, for example, an impression analysis of a makeup following the seasonal trend can be supplied.

### (Impression Analysis Method)

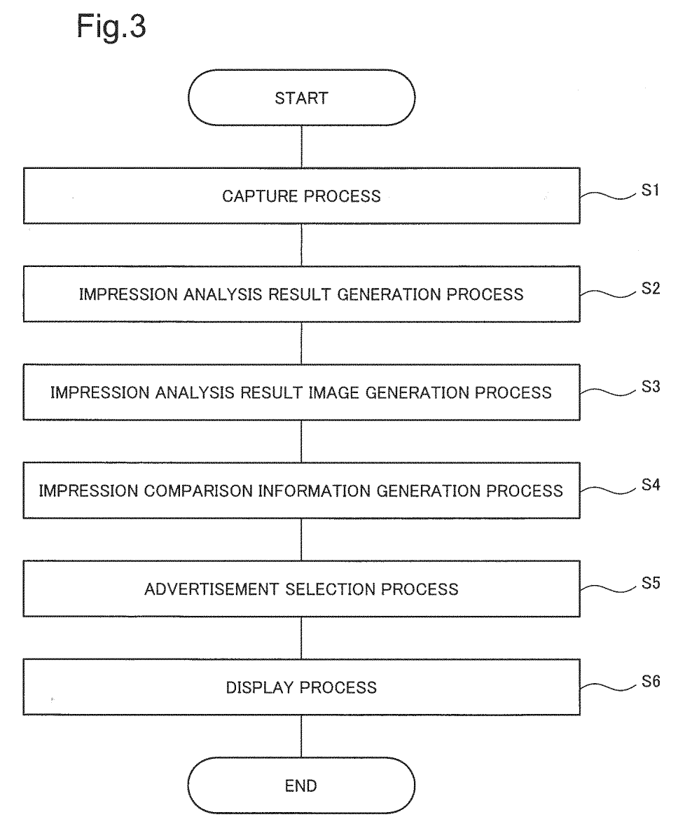

An impression analysis method of the current exemplary embodiment is described with reference to FIG. 3. The impression analysis method of the present exemplary embodiment is, for example, is executed as described below utilizing the impression analysis system of the present exemplary embodiment shown in FIG. 1. However, the impression analysis method of the present exemplary embodiment is not limited to utilizing the impression analysis system.

Firstly, before executing the impression analysis method of the present exemplary embodiment, a plurality of facial images are prepared, and an impression evaluation by an impression evaluator for each facial image is acquired. Specifically, as one example of acquiring an impression evaluation, for example, the impression evaluator inputs an impression evaluation for the facial image, against the facial image displayed on a terminal by an output unit. Secondly, the facial image and the impression evaluation against the facial image by the impression evaluator are associated and stored in a database (the storage unit 11) as impression information. Then, the learning unit 12 extracts a feature point from each facial image, and generates an evaluation criterion with reference to the impression information.

An execution of the impression analysis method of the present exemplary embodiment is described below with reference to block diagrams shown in FIGS. 1 and 2, and a flowchart shown in FIG. 3. The person to be evaluated firstly captures his facial image using the input terminal 1A (S1). The facial image of the person to be evaluated may be, for example, stored in the storage unit 11. Then, the impression analysis result generation unit 13 generates an impression analysis result from the facial image of the person to be evaluated, based on the evaluation criterion generated by the learning unit 12 (S2). In the process S2, the impression analysis result generation unit 13 may generate an impression analysis result by using the facial image stored in the storage unit 11. Then the impression analysis result image generation unit 14 generates an impression analysis result image based on the generated impression analysis result generated by the impression analysis result generation unit 13 (S3). Then the impression comparison information generation unit 15 compares the impression analysis results generated by the impression analysis result generation unit 13, and generates an impression comparison result (S4). Then, the advertisement selection unit 16 selects an advertisement according to the impression analysis result of the person to be evaluated (S5). Then, the output terminal 1B displays the impression analysis result, impression analysis result image, advertisement information and the impression comparison result (S6). S3 to S5 are arbitrary elements. Also, the order of S3 to S5 is not limited. For example, S4 or S5 may be executed before S3.

The impression analysis method of the present exemplary embodiment is described above, while an application of the impression analysis system to the cosmetic industry is described below.

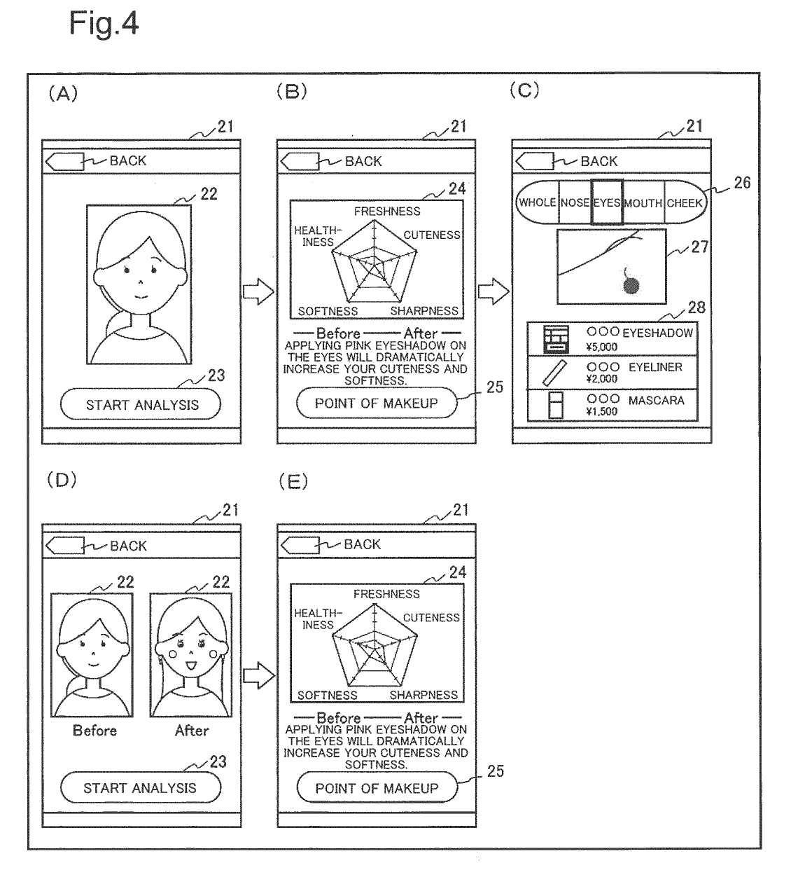

Firstly, the person to be evaluated (female) launches an impression evaluation tool on her smartphone (input terminal). Then, the person to be evaluated uploads her facial image stored on the smartphone or captured using a camera mounted on the smartphone, to the impression analysis result tool. Then, as shown in status (A) of FIG. 4, on the smartphone 21, the “start analysis” button 23 is displayed with the uploaded facial image 22. Then, after the person to be evaluated clicks the “start analysis” button 23, the screen of the smartphone 21 switches to a screen shown in status (B) of FIG. 4.

In status (B) of FIG. 4, the impression analysis result of the facial image is displayed with the radar chart 24. In the radar chart 24, as shown in status (B) of FIG. 4, impression elements “freshness”, “cuteness”, “healthiness”, “softness”, and “sharpness” are displayed by five-grade evaluation. In status (B) of FIG. 4, in the impression analysis result of the person to be evaluated, the evaluation is 1 in the freshness, 1 in the cuteness, 2 in the healthiness, 1 in the softness, and 2 in the sharpness.

Although not shown in status (B) of FIG. 4, the impression evaluators of the impression analysis result are composed only by specialists of beauty care. Besides, under the radar chart 24, “Before” and “After” are displayed. Here, “Before” corresponds to the impression analysis result of the facial image. “After” corresponds to an impression evaluation in the case the facial image is modified (simulation makeup is applied) based on the impression analysis result including an advice. In the case of “After,” in the radar chart 24, the evaluation is 2 in freshness, 3 in cuteness, 3 in healthiness, 3 in softness, 3 in sharpness. Besides, under the display of “Before” and “After”, “Applying pink eyeshadow on the eyes will dramatically increase your cuteness and softness.” is displayed as an advice. Under the advice, the “point of makeup” button 25 is displayed. Then, when the person to be evaluated clicks the button 25, the smartphone screen switches to the screen shown in status (C) of FIG. 4.

In status (C) of FIG. 4, “whole”, “nose”, “eyes”, “mouth” and “cheek” tabs 26 are displayed, and the “eyes” is selected. Under the tab 26, an enlarged image 27 of the eyes of the modified facial image is displayed. Under the enlarged image 27, as suitable products for the makeup tip, an advertising information 28 of an eyeshadow, an eyeliner, and a mascara are shown.

In the above example, a case that the makeup simulation is carried out automatically is described. However, the person to be evaluated may capture and compare her facial images before and after applying a makeup respectively. Specifically, as shown in status (D) of FIG. 4, the person to be evaluated can capture a facial image before applying makeup (Before) and a facial image after applying makeup (After) and compare the facial images before and after applying makeup, as shown in status (E) of FIG. 4.

In the above example, the person to be evaluated is exemplified as a female; however, the person to be evaluated can be a male, and an application for male cosmetics is possible. Application examples include an evaluation of favorable impression of a businessman observed by a client (a stranger) and the like.

### The Second Exemplary Embodiment

An impression analysis system of the present exemplary embodiment is identical to the impression analysis system in the first exemplary embodiment, except that an impression analysis device 2A includes an impression information registration unit and an impression information detection unit.

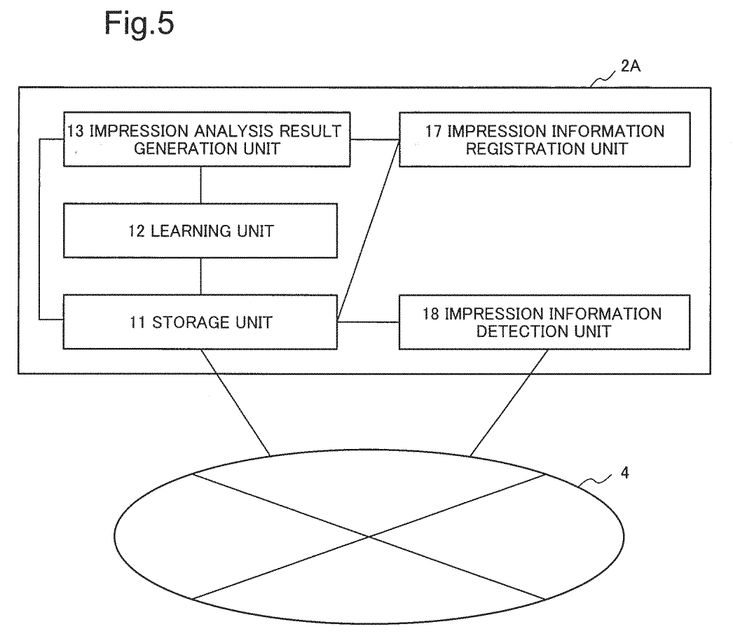

FIG. 5 is a block diagram showing one example of a configuration of the impression analysis device 2A in the present exemplary embodiment. The impression analysis device 2A of the present exemplary embodiment shown in FIG. 5 is, as described above, identical to the impression analysis device 2 of the first exemplary embodiment except that an impression information registration unit 17 and an impression information detection unit 18 are included. As shown in FIG. 5, the impression information detection unit 18 is able to be connected to the communication line network 4. The impression information registration unit 17 associates a facial image of a person to be evaluated, identification information of the person to be evaluated, and an impression analysis result generated by the impression analysis result generation unit 13, and stores onto the storage unit 11 as impression information. The impression information detection unit 18 detects a specified impression evaluation and impression information that matches the impression analysis result of the impression information stored in the storage unit 11. In FIG. 5, the impression analysis result image generation unit 14, the impression comparison information generation unit 15 and the advertisement selection unit 16 of the first exemplary embodiment are not shown, and these may be included or excluded in the present exemplary embodiment.

Examples of the identification information include, without limitation, for example, a name of the person to be evaluated, an attribute such as age or gender and the like, occupation, income, hometown, education, area of specialty, hobby, address, phone number, e-mail address and the like.

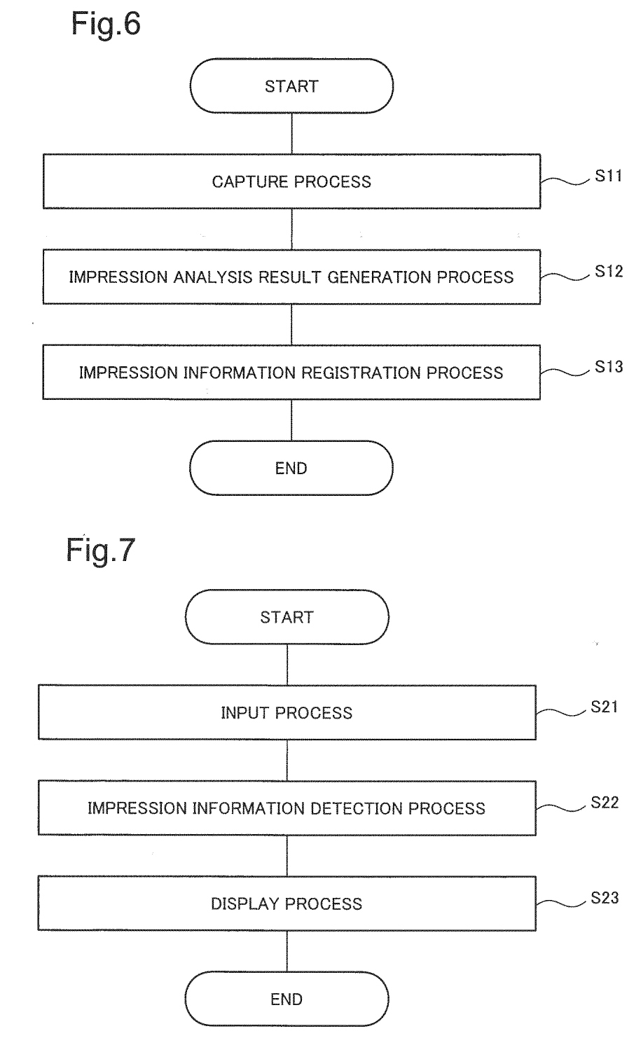

The execution of the impression analysis method of the present exemplary embodiment is described below with reference to the block diagram shown in FIG. 5 and the flowcharts shown in FIGS. 6 and 7.

Firstly, a registration method of impression information of a person to be evaluated is described with reference to the flowchart of FIG. 6. A person to be evaluated firstly carries out the same steps of S1 to S2 of the first exemplary embodiment (S11 to S12), except for inputting identification information using an input terminal. Then, the impression information registration unit 17 associates a facial image of the person to be evaluated, the identification information of the person to be evaluated, and an impression analysis result generated by the impression analysis result generation unit 13, and stores onto the storage unit 11 as impression information (S13).

Then, an impression information detection method is described with reference to the flowchart of FIG. 7. The user firstly inputs a specific impression evaluation using an input terminal (S21). Then, the impression information detection unit 18 detects a specific impression evaluation and impression information that matches the impression analysis result of impression information stored on the storage unit 11 (S22). Then, an output terminal displays the matched impression information (S23).

The impression analysis method of the present exemplary embodiment is described above, while an application of the impression analysis system in the marriage support industry is described specifically below.

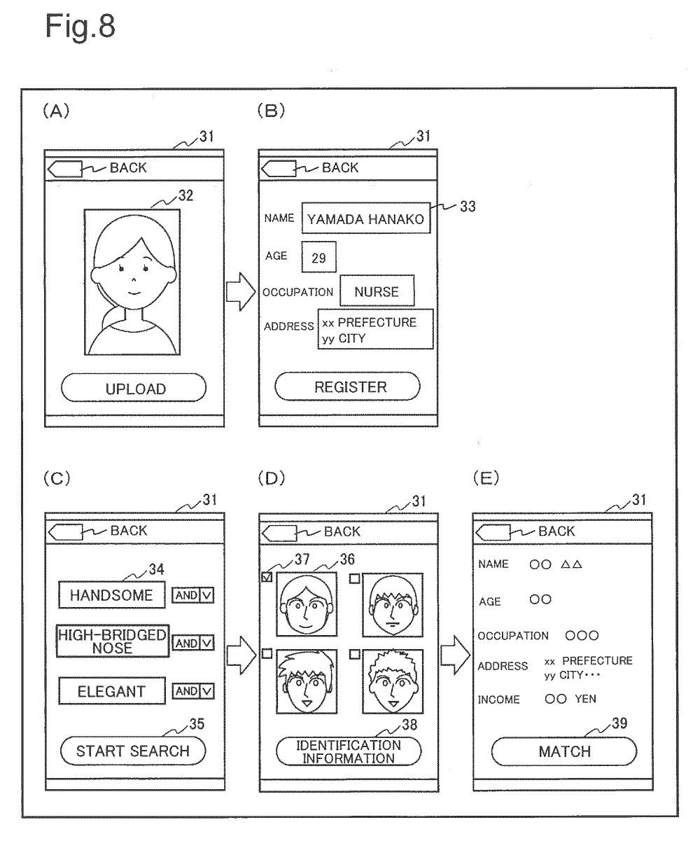

Firstly, a user (female) launches an impression analysis tool on her smartphone (input terminal). Then, the user, as shown in status (A) of FIG. 8, uploads a captured facial image 32 using a camera mounted on the smartphone 31. Then, the user, as shown in status (B) of FIG. 8, inputs her name (Hanako Yamada), age (29), occupation (nurse), and address (xx prefecture yy city . . . ) into the input form 33 as the identification information of the facial image. Then, an impression information registration unit (not shown in the diagram) associates the female user's facial image, the identification information, the impression analysis result generated by an impression analysis generation unit (not shown in the diagram) such as beautiful, neat, big eyes, and registers onto a database (storage unit) as impression information.

Then, the female user, as shown in status (C) of FIG. 8, with her smartphone 31, inputs a favorite type of person of the opposite sex (handsome, high-bridged nose, elegant) in the input form 34. Then, after the search start button 35 is clicked, facial images 36 that match the type are detected, as shown in status (D) of FIG. 8. Then, the female user further inputs a check mark into the checkbox 37 of a facial image of her type. As shown in Fig. status (D) of FIG. 8, in this example, a facial image at the left top has a check mark. Then, after the identification information button 38 is clicked, as shown in the diagram, the identification information of the checked facial image (name, age, occupation, income and address) is displayed. Here, the female user confirms the identification information of the facial image, and if she likes it, she clicks the matching button 39. Consequently the impression information of the female user is sent to the male of the facial image. In this way, the impression analysis system can be suitably utilized as a marriage assistance system.

The above example is exemplified as a marriage system without limitation, and it can suitably be utilized for setting a matchmaking party, a spouse hunting party and the like.

Also, as another example, specifically, the impression analysis system can be utilized suitably at an application document selection process of an interview examination in which certain impressions are specified and applicants are selected accordingly. Examples of specific impressions include, motivated, cheerful, clean and the like.

### The Third Exemplary Embodiment

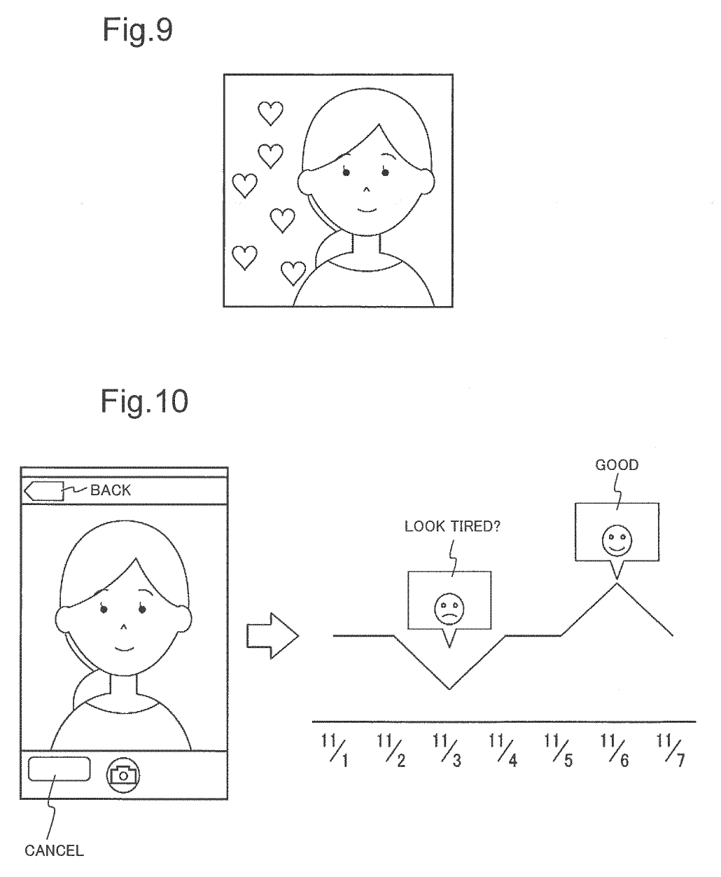

In the present exemplary embodiment, a game device that includes the impression analysis device in the first exemplary embodiment is described. A game device may be, for example, only the impression analysis device, or a combination of the impression analysis device and an existing game device or instrument including an image capture unit. As a game device, in the case the impression analysis device is utilized independently, by displaying a degree of handsomeness, beauty, sexual attractiveness and the like as the impression analysis result, the impression analysis device may be utilized at a male or female beauty pageant or the like. Also, an impression analysis device may be, for example, installed for household use, or at a video game arcade, or at a theme park such as an amusement park, as a game device for comparing an impression with that of a celebrity, a friend, or a previous person to be evaluated. On the other hand, in the case the impression analysis device is combined with an existing game device or instrument, examples of the existing game devices include, specifically, a photo booth such as Print Club (trademark) and the like. Also, in the case of a game device in which the impression analysis device is combined with Print Club (trademark), for example, as shown in FIG. 9, an impression analysis result can be displayed on a photo sticker by displaying a degree of beauty with a number of heart marks and the like. Moreover, with Print Club (trademark), for example, when a request to increase a degree of cuteness is inputted, a shooting may occur with eyes automatically enlarged, front hair changed to a cute style and the like, in order to express a result of the request.

### The Fourth Exemplary Embodiment

In the present exemplary embodiment, a health management device including the impression analysis device 2 or 2A in the first exemplary embodiment is described. A health management device can be, for example, only the impression analysis device 2 or 2A, or a combination of the impression analysis device and an existing health management device. In the case the impression analysis device 2 or 2A is utilized independently, for example, as shown in FIG. 10, as a daily health record derived from daily facial images, changes of the health may be graphed in a line graph. In this case, suitable uses for a long distance bus driver, a health management of a student athlete, an inpatient, or someone who cannot communicate clearly that he is sick such as an infant or a child, are possible. Also, as shown in FIG. 10, in the case a facial image on November 3 has an impression analysis result as tired, and a facial image of November 6 has an impression analysis result as cheerful, a corresponding mark or a comment can be added. In the case that the impression analysis device is combined with an existing health management device, specifically, the impression analysis device can be combined with, for example, a thermometer, a weight meter, a sphygmomanometer or the like as the existing health management device, and can be combined with an automatic nurse call system and the like.

### The Fifth Exemplary Embodiment

In the present exemplary embodiment, an advertising support device including the impression analysis device in the first exemplary embodiment is described. An advertising support device may be, for example, only the impression analysis device, or a combination of the impression analysis device and an existing advertisement device. Specific examples of advertisement devices include a digital signage and the like. In this case, by acquiring an impression analysis result by the public by making an unspecified number of public persons watching the digital signage the persons to be evaluated, a status of the watchers such as interested, likely to buy can be comprehended.

### The Sixth Exemplary Embodiment

A program of the present exemplary embodiment is a program that is able to execute the impression analysis method of the first exemplary embodiment on a computer. The program of the present exemplary embodiment can be recorded on a storage media. Examples of storage medium include, without limitation, a Read Only Memory (ROM), a hard disk (HD), an optical disk, floppy (trademark) disk (FD) and the like.

The present invention has been described above by referring to the exemplary embodiments. However, the present invention is not intended to be limited by the above exemplary embodiments. It is possible to make various modifications those skilled in the art can understand to the configuration and the details of the present invention within the scope of the present invention.

The present invention has been described with the above-described exemplary embodiments as ideal examples. However, the present invention is not limited by the above-described exemplary embodiments. Thus, within the scope of the present invention, it is possible to apply various aspects that those skilled in the art can understand to the present invention.

### REFERENCE SIGNS LIST

1 Input Terminal and Output Terminal
2 Impression Analysis Device
3 Server
4 Communication Line Network
10 Impression Analysis System
11 Storage Unit
12 Learning Unit
13 Impression Analysis Result Generation Unit
14 Impression Analysis Result Image Generation Unit
15 Impression Comparison Information Generation Unit
16 Advertisement Selection Unit
17 Impression Information Registration Unit
18 Impression Information Detection Unit

What is claimed is:

1. An impression analysis device comprising:
a storage unit that stores, as impression information, a preliminarily acquired facial image and an impression evaluation with respect to the facial image by an impression evaluator, to be stored in such a manner that the facial image is associated with the impression evaluation;
a learning unit that extracts a feature point from the facial image and generates an evaluation criterion by referring to the impression information; and
an impression analysis result generation unit that generates an impression evaluation result from a facial image of a person to be evaluated, based on the evaluation criterion generated by the learning unit.

2. The impression analysis device according to claim 1, wherein the impression evaluator is composed of a person who belongs to at least one of a group consisting of a specific business type, job type, and attribute.

3. The impression analysis device according to claim 1, wherein
the impression evaluation includes an impression evaluation of the impression evaluator according to a specific situation against the facial image, and
the impression analysis result generation unit generates the impression analysis result according to the specific situation.

4. The impression analysis device according to claim 1, wherein the impression analysis result includes an estimation result of the impression evaluation given by the impression evaluator, and in addition to the estimation result, includes at least one of an advice and a recommendation according to a purpose of use.

5. The impression analysis device according to claim 1, further comprising an impression information registration unit that associates and stores a facial image of the person to be evaluated, identification information of the person to be evaluated, and the impression analysis result generated by the impression analysis result generation unit, onto the storage unit as impression information.

6. The impression analysis device according to claim 5, further comprising an impression information detection unit that detects a specific impression evaluation and impression information that matches the impression analysis result of the impression information stored in the storage unit.

7. The impression analysis device according to claim 1, further comprising an impression analysis result image generation unit that generates an impression analysis result image based on the impression analysis result generated by the impression analysis result generation method.

8. The impression analysis device according to claim 7, wherein the impression analysis result image includes a facial image that is a modification of the facial image of the person to be evaluated, based on the impression analysis result.

9. The impression analysis device according to claim 1, further comprising an impression comparison information generation unit that generates an impression comparison result by comparing an impression analysis result of each facial image generated by the impression analysis result generation unit.

10. The impression analysis device according to claim 1, further comprising an advertisement selection unit that selects an advertisement according to the impression analysis result of the person to be evaluated.

11. The impression analysis device according to claim 1, further comprising:
an input unit and an output unit; wherein
the input unit comprises at least one of a unit that inputs the specific impression evaluation and a unit that captures a facial image of the person to be evaluated, and
the output unit comprises at least one of a unit that displays the detected impression information, and a unit that displaying at least one from the group consisting of the impression analysis result generated by the impression analysis result generation unit, the impression analysis result image, the advertisement information, and the impression comparison result.

12. A game device comprising the impression analysis device according to claim 1.

13. A health management device comprising the impression analysis device according to claim 1.

14. An advertising support device comprising the impression analysis device according to claim 1.

15. An impression analysis system comprising:
a server including the impression analysis device according to claim 1;
an input terminal; and
an output terminal; wherein
the input terminal and the output terminal are connected to the server via a communication line network;
the input terminal comprises at least one of a unit, that inputs the specific impression evaluation and a unit that captures a facial image of the person to be evaluated; and
the output terminal comprises at least one of a unit that displays the detected impression evaluation and a unit that displays at least one from the group consisting of the impression analysis result generated by the impression analysis result generation unit, the impression analysis result image, the advertisement information, and the impression comparison result.

16. An impression analysis method comprising:
storing, as impression information, a preliminarily acquired facial image and an impression evaluation with respect to the facial image by an impression evaluator, to be stored in such a manner that the facial image is associated with the impression evaluation;
extracting a feature point from the facial image and generating an evaluation criterion by referring to the impression information; and
generating an impression analysis result based on a facial image of a person to be evaluated, using the evaluation criterion.

17. The impression analysis method according to claim 16, wherein the impression evaluator is composed of a person who belongs to at least one of the group consisting of a specific business type, job type and attribute.

18. The impression analysis method according to claim 16, wherein the impression information associates the facial image with an impression evaluation by an impression evaluator according to a specific situation against the facial image, and the impression analysis result is generated according to the specific situation.

19. The impression analysis method according to claim 16, wherein the impression analysis result includes an estimation result of an impression evaluation given by the impression evaluator, and in addition to the estimation result, includes at least one of an advice and a recommendation according to a purpose of use.

20. The impression analysis method according to any one of claim 16, wherein the impression information includes an association with the facial image of the person to be evaluated, the identification information of the person to be evaluated and the impression analysis result.

21. The impression analysis method according to claim 20, further comprising detecting impression information that matches a specific impression evaluation and the impression analysis result of the impression information stored in the storage unit.

22. The impression analysis method according to claim 16, further comprising generating an impression analysis result image based on the impression analysis result.

23. The impression analysis method according to claim 22, wherein the impression analysis result image includes a modified facial image of the person to be evaluated, based on the impression analysis result.

24. The impression analysis method according to claim 16, further comprising selecting an advertisement according to the impression analysis result of the person to be evaluated.

25. The impression analysis method according to claim 16, wherein an impression comparison result is generated by comparing the impression analysis result of each of the facial images.

26. The impression analysis method according to claim 16, further comprising:
executing at least one of inputting the specific impression evaluation and capturing a facial image of the person to be evaluated; and
executing at least one of displaying the detected impression information and displaying at least one of the group consisting of the impression analysis result, the impression analysis result image, the advertisement information, and the impression comparison result.

27. A computer-readable program storage media storing a program storing:
a storing process that stores, as impression information, a preliminarily acquired facial image and an impression evaluation with respect to the facial image by an impression evaluator, to be stored in such a manner that the facial image is associated with the impression evaluation;
a learning process that extracts a feature point from the facial image and generates an evaluation criterion by referring to the impression information; and
an impression analysis result generation process that generates an impression analysis result from a facial image of the person to be evaluated, based on the generated evaluation criterion generated by the learning process.
